(19) United States
(12) Patent Application Publication
(10) Pub. No.: US 2015/0373435 A1
(43) Pub. Date: Dec. 24, 2015

(54) COAXIAL AUDIO SPEAKER USING SINGLE AUDIO SOURCE

(71) Applicant: Huiyang Dongmei Audio Products Co., Ltd., Guang Dong (CN)

(72) Inventors: Ming-Chung CHU, New Taipei City (TW); Taniguchi SHOICHI, Nara (JP)

(21) Appl. No.: 14/309,182

(22) Filed: Jun. 19, 2014

(51) Int. Cl. H04R 1/00; H04R 7/00

(52) U.S. Cl. CPC H04R 1/00; H04R 7/00

(57) ABSTRACT

A disclosed coaxial audio speaker may include a treble sound unit and a bass sound unit co-axially surrounding the treble sound unit. The bass sound unit may be in form of a single magnetic gap mechanism and have a vibrating vocal tone diaphragm along with a wiring board. The bass sound unit may further include a magnetic resistant ring selectively disposed therein. Within the magnetic resistant ring lies the treble sound unit. Therefore, the size of the audio speaker may be reduced because of the co-axially disposed bass sound unit and the treble sound unit. And the broader electricity adjustability may be achieved as vibration audio source points of the bass sound unit and the treble sound unit may be horizontally aligned.

### BACKGROUND

1. Technical Field

The present disclosure relates to an audio speaker, in particular, to a coaxial audio speaker using a single audio source. Specially, the audio speaker employs a bass sound unit and a treble sound unit surrounded by the bass sound unit. Further, a vibration audio source point of the bass sound unit and a vibration audio source point of the treble sound unit may be aligned at the same horizontal level.

2. Description of Related Art

Traditional earphones or audio speakers are equipped with one single amplifier (sound unit) and that renders difficult the realization of a broad range of listening experience. And certain tradeoff becomes necessary if the bass performance needs to be enhanced (at the expense of the treble performance). Even for achieving the goal of the above mentioned broad listening experience, multiple separate sound units (for example, distinct treble sound unit and bass sound unit) need to be placed within the earphones or the audio speakers, occupying additional space inside the earphones or the audio speakers and inevitably increasing the size of the same.

### SUMMARY OF THE DISCLOSURE

In order to overcome the aforementioned deficiency, the present disclosure provides a coaxial audio speaker using a single audio source. Specifically, the present disclosure audio speaker may have the bass sound unit coaxially surrounding the treble sound unit, effectively reducing the size of the audio speaker. Meanwhile, the present disclosure audio speaker may be adapted to have vibration audio source points at the same horizontal level, enabling a broader range of electricity adjustability for the sound units.

The coaxial audio speaker according to the present disclosure may include a treble sound unit with a vibration audio source point and a wiring board, and a bass sound unit in form of a single magnetic gap mechanism with a vibrating vocal tone diaphragm having a single vocal coil, and a wiring board. The bass sound unit may be associated with another vibration audio source point. The bass sound unit and the treble sound unit may be coaxially disposed and the treble sound unit may be adapted to be surrounded by the bass sound unit. The vibration audio source point of the treble sound unit may horizontally align with the vibration audio source point of the bass sound unit.

Specifically, the treble sound unit may be an electromagnetic moving iron sound unit, a circular electromagnetic sound unit, a rectangular electromagnetic sound unit, a moving-coil sound unit, piezo-ceramic sound piece components, a piezo-ceramic sound piece adjoining another vibrating vocal tone diaphragm or a semiconductor chip sound unit.

Specifically, a magnetic resistant ring may be disposed at the position where the co-axially disposed bass sound unit and treble sound unit adjoin, for separating a magnetic field of the bass sound unit and a magnetic field of the treble sound unit.

Specifically, the magnetic resistant ring may be a column structure allowing for the treble sound unit to punch through and position therein with a magnetic-conductive base of the bass sound unit surrounding the magnetic resistance ring.

Specifically, the bass sound unit may further include a ring-shaped magnetic-conductive base, which defines a hollow positioning space at its center within which the treble sound unit is positioned, and a main body of the ring-shaped magnetic-conductive base has a ring-shaped accommodating space having a top opening. The main body of the ring-shaped magnetic-conductive base forms an inner wall and an outer wall of the top opening. The bass sound unit may also include a ring-shaped first magnet disposed in an inner ring and attached to the inner wall and a ring-shaped second magnet disposed in an outer ring and attached to the outer wall. The ring-shaped first magnet and the ring-shaped second magnet together could define a magnetic gap. Plus, the bass sound unit may also include a first magnetic-conductive ring stationed on a top surface of the ring-shaped first magnet and a second magnetic-conductive ring stationed on a top surface of the ring-shaped second magnet. The vibrating vocal tone diaphragm may include a ring-shaped diaphragm membrane stationed on ends of the inner wall and the outer wall of the main body of the ring-shaped magnetic-conductive base. And a vocal coil may be disposed on a bottom of the ring-shaped diaphragm membrane and may form the vibration audio source point at its connection with the ring-shaped diaphragm membrane, brane, and the single vocal coil extends into the magnetic gap between the ring-shaped first magnet and the ring-shaped second magnet. The bass sound unit may further include the wiring board disposed on an external bottom surface of the ring-shaped magnetic-conductive base providing connection wires for positioning the vocal coil.

The vibrating vocal tone diaphragm may further include an external pressurized frame positioned at an outer ring edge of the ring-shaped diaphragm membrane and an inner pressurized frame positioned at an inner ring edge of the ring-shaped diaphragm membrane. The inner pressurized frame connects to the end of the inner wall of the ring-shaped magnetic-conductive base, and the outer pressurized frame connects to the end of the outer wall and encloses the top opening of the ring-shaped magnetic-conductive base.

A vent hole is disposed on the external bottom surface of the ring-shaped magnetic-conductive base allowing for an air associated with the vibration of the vibrating vocal tone diaphragm to be channeled out of the ring-shaped accommodating space.

A flow damping gauze may be adhesively attached on the external bottom surface of the ring-shaped magnetic-conductive base for adjusting an air flow within the accommodating space.

The ring-shaped diaphragm membrane is in form of composite diaphragm material.

Dust covers may be disposed over the bass sound unit and the treble sound unit, respectively, with a first dust cover having a first sound hole as a bass sound hole allowing for the sound from the bass sound unit to be transmitted out of the first dust cover, and a second dust cover having a second sound hole as a treble sound hole allowing for the sound from the treble sound unit to be transmitted out of the second dust cover.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows an exploded view of a coaxial audio speaker according to one embodiment of the present disclosure;

FIG. 2 shows a cross-sectional view of the audio speaker in FIG. 1 according to one embodiment of the present disclosure;

FIG. 3 shows a front view of the audio speaker in FIG. 1 according to one embodiment of the present disclosure;

FIG. 4 shows a back view of the audio speaker in FIG. 1 according to one embodiment of the present disclosure;

FIG. 5 is another audio speaker according to one embodiment of the present disclosure;

FIG. 6 is an exploded view of the audio speaker in FIG. 5 according to one embodiment of the present disclosure;

FIGS. 7A-7F show the embodiments of the treble sound unit according to one embodiment of the present disclosure; and

FIG. 8 is a schematic diagram of a vibrating vocal tone diaphragm of the audio speaker according to one embodiment of the present disclosure.

### DESCRIPTION OF THE EXEMPLARY EMBODIMENTS

The aforementioned and other technical contents, features, and efficacies will be shown in the following detail descriptions of a preferred embodiment corresponding with the reference Figures.

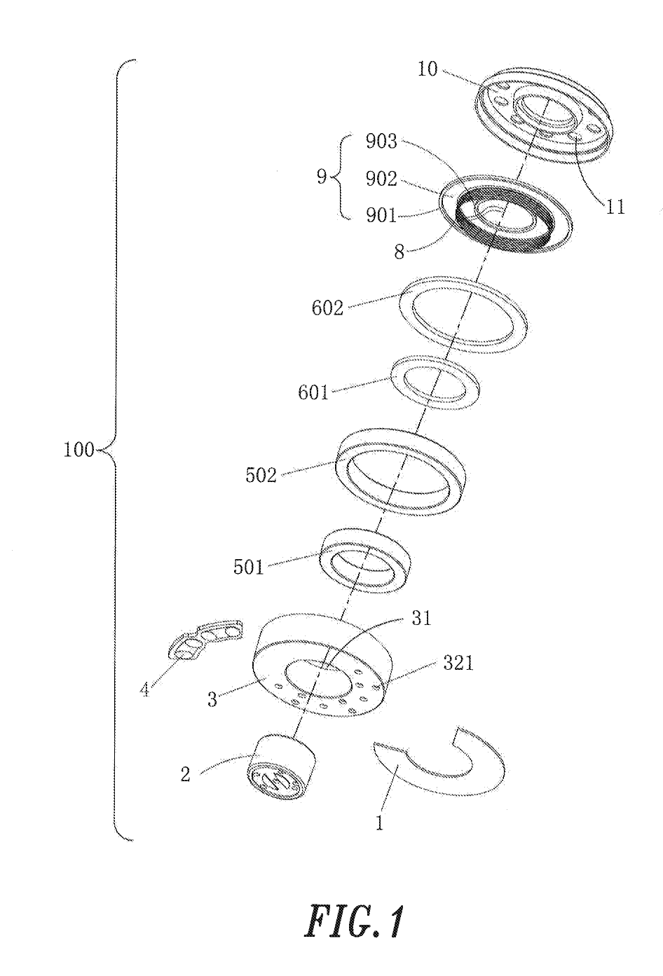

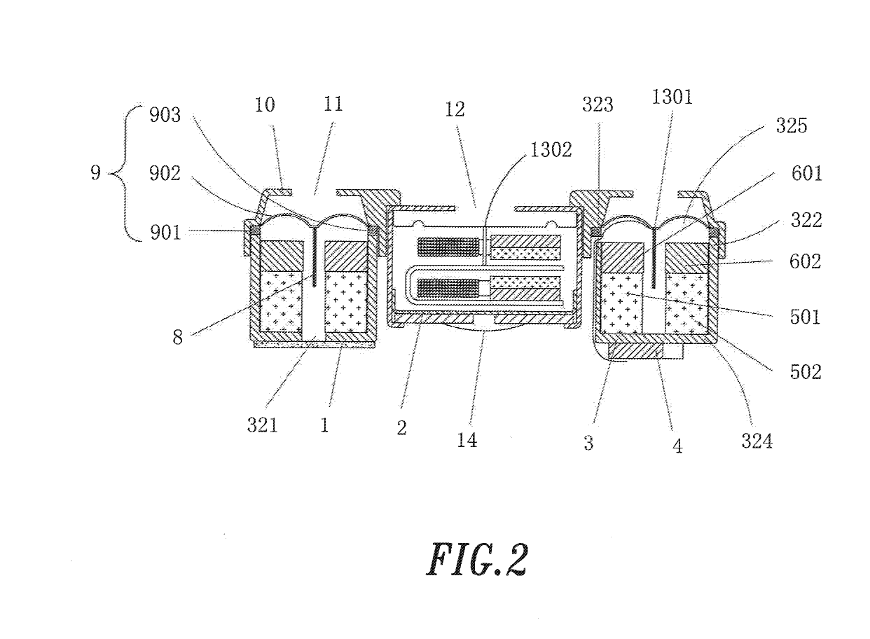

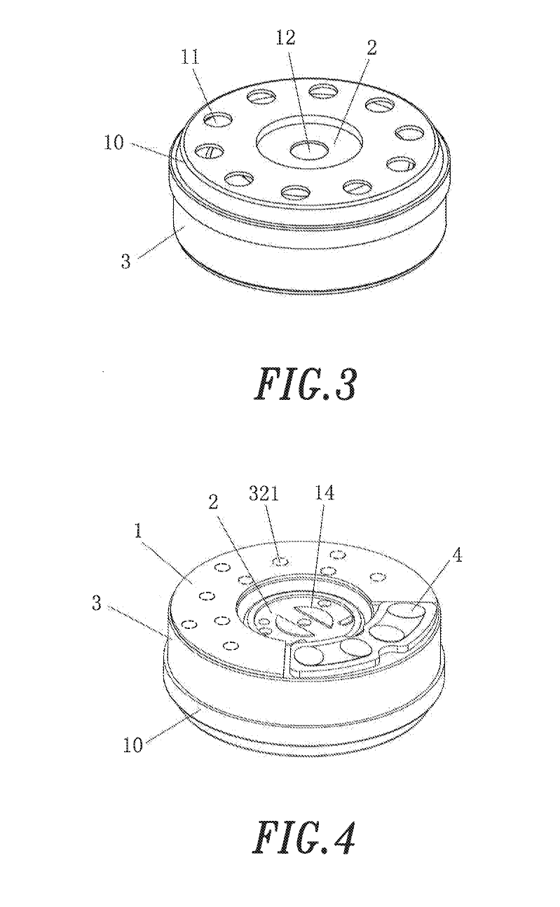

Please refer to FIGS. 1-4 illustrating a coaxial audio speaker using a single audio source according to one embodiment of the present disclosure. The audio speaker may include a combination of a bass sound unit 100 and a treble sound unit 2, with the bass sound unit 100 and the treble sound unit 2 coaxially disposed. And the bass sound unit 100 may coaxially surround the treble sound unit 2. The treble sound unit 2 may include a vibration audio source point 1302 and a wiring board 14 for the treble sound unit 2 (Please refer to FIG. 2). In one implementation, the treble sound unit 2 may be a moving iron treble sound unit.

The bass sound unit 100 may be implemented in terms of a single magnetic gap mechanism. The bass sound unit 100 may include a ring-shaped magnetic-conductive base 3. A positioning space 31 may be formed at a hollow center of the ring-shaped magnetic-conductive base 3. A main body of the ring-shaped magnetic-conductive base 3 may include an accommodating space 32 with a top opening 325 formed by an inner wall 323 and an outer wall 322. Away from the top opening 325 defines an enclosed bottom surface 324 where a vent hole 321 is placed.

A ring-shaped first magnet 501 and a ring-shaped second magnet 502 may be positioned within the accommodating space 32 of the ring-shaped magnetic-conductive base 3. In one implementation, the size of the first magnet 501 is smaller than the size of the second magnet 502 though the cross sections and heights of the first magnet 501 and the second magnet 502 are smaller than the cross section and the height of the accommodating space 32. Both the first magnet 501 and the second magnet 502 may be stationed on the enclosed bottom surface 324 with their bottom surfaces. Specifically, the first magnet 501 may be attached to the wall surface of the inner wall 323 of the accommodating space 32 while the second magnet 502 may be attached to the wall surface of the outer wall 322 of the accommodating space 32. Accordingly, the first magnet 501 and the second magnet 502 collectively may form a magnetic gap within the accommodating space 32.

A first magnetic-conductive ring 601 may be adhesively attached to a top surface of the first magnet 501 and a second magnetic-conductive ring 602 may be adhesively attached to a top surface of the second magnet 502. With the above arrangement, the first magnet 501, the second magnet 502, the first magnetic-conductive ring 601 and the second magnetic-conductive ring 602 may be within the accommodating space 32. At the same time, the first magnetic-conductive ring 601 and the second magnetic-conductive ring 602 may not protrude from the top opening 325.

A vibrating vocal tone diaphragm 9 may be integrated with the top opening 325. The vibrating vocal tone diaphragm 9 may be composed by a ring-shaped external pressurized frame 901, a diaphragm membrane 902, and a ring-shaped internal pressurized frame 903. The ring-shaped diaphragm membrane 902 may be with an outer ring edge and an inner ring edge. The inner ring edge may be where the ring-shaped inner pressurized frame 903 is positioned while the outer ring edge may be where the ring-shaped external pressurized frame 901 is positioned. A single vocal coil 8 may be adhesively placed at the bottom of the diaphragm membrane 902 and placed between the inner pressurized frame 903 and the outer pressurized frame 901. The location where the single vocal coil 8 and the diaphragm membrane 902 are adjoined may form a vibration audio source point 1301. The external pressurized frame 901 of the vibrating vocal tone diaphragm 9 may be adhesively attached to the outer wall 322 of the top opening 325 with the inner pressurized frame 903 of the vibrating vocal tone diaphragm 9 adhesively attached to the inner wall 323. The single vocal coil 8 may end up being positioned within the accommodating space 32 and within the magnetic gap between the first magnet 501 and second magnet 502. The vibrating vocal tone diaphragm 9 may enclose the top opening 325.

Magnetic fields provided by the first magnet 501 and the second magnet 502 may be conductive present the first magnetic-conductive ring 601 and the second magnetic-conductive ring 602 along with the vocal coil 8 providing the magnetic gap and the magnetic-conductive base 3 further serving to render conductive the magnetic fields. The vent hole 321 may allow for the air associated with the vibration of the vibrating vocal tone diaphragm 9 to be channeled out.

As shown in FIG. 8, the diaphragm membrane 902 may be a composite diaphragm material such as polymer plastic, plastic polymer fibers, organic fibers, mineral matters or the like and in the form of a thin film, or a composite thin film 9021. The mineral matters may include metals, rocks, minerals, glasses or the combinations of the above. In another implementation, the diaphragm membrane 902 may be formed by braided-type punching and forming. The outer pressurized frame 901 or the inner pressurized frame 903 may not be ring-shaped. In other words, the outer pressurized frame 901 or the inner pressurized frame 903 may be oval, triangular, rectangular, polygonal, or in other shape.

A wiring board 4 may be adhesively attached to an external bottom wall of the magnetic-conductive base 3. The wiring board 4 may allow for the vocal coil 8 to be positioned by welding.

That the treble sound unit 2 is positioned within the accommodating space 3 may be by adhesion, engaging, or other commercially available connecting approaches. The bass sound unit 100 may co-axially surround the treble sound unit 2 with the vibration audio source point 1301 of the bass sound unit 100 may be at the same horizontal level with a vibration audio source point 1302 of the treble sound unit 2. Thus, the audio speaker according to the present disclosure may be with a broader range of electricity adjustability even with one single audio source.

The wiring board 14 of the magnetized treble sound unit and the wiring board 4 of the magnetized bass sound unit may be connected to electrical signal wires.

The magnetic-conductive base 3 may be having flow damping gauze 1 adhesively attached to its external bottom wall. The flow damping gauze 1 may cover the vent hole 321 and may be for adjusting the air flow within the accommodating space 32.

Above the bass sound unit 100 may overlay a first dust cover 10. The sound from the bass sound unit 100 may be channeled through a first sound hole 11 as a bass sound hole of the first dust cover 10, while the sound from the treble sound unit 2 may be channeled through a second sound hole 12 as a treble sound hole of another dust cover. It is worth noting that the bass sound unit 100 and the treble sound unit 2 may not share the same dust cover (e.g., the first dust cover 10).

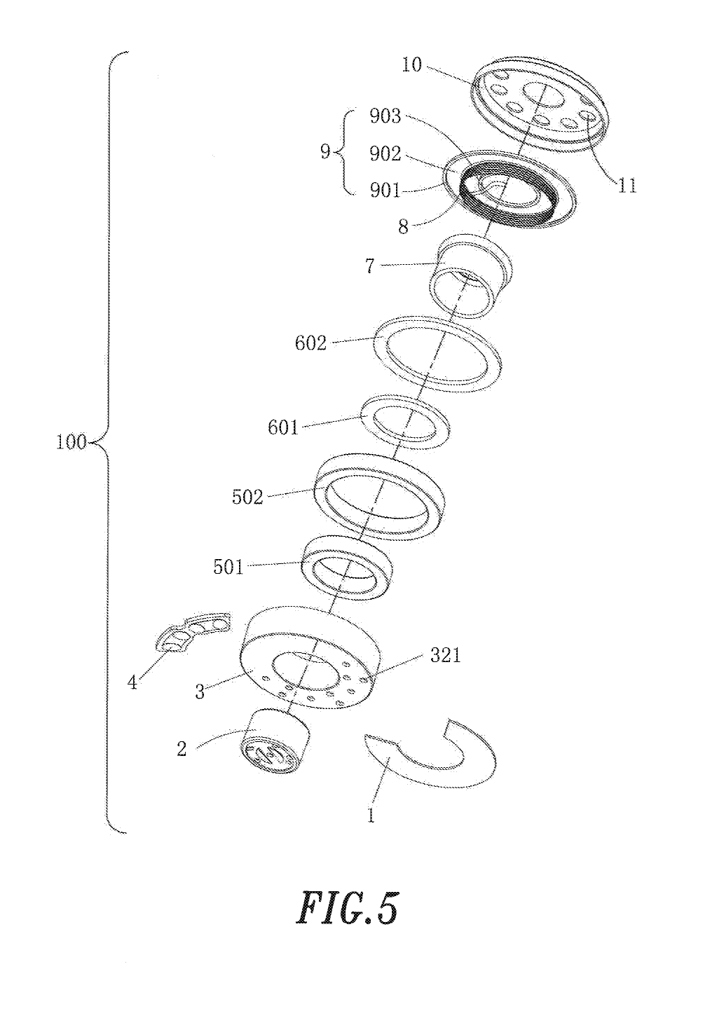

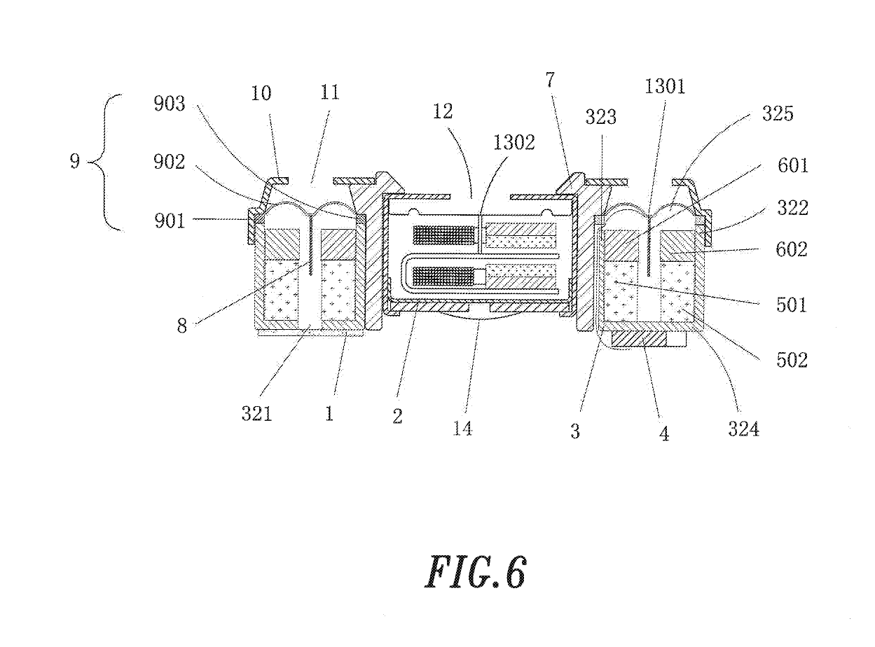

Please refer to FIGS. 5-6 illustrating another embodiment according to the present disclosure. Difference between the embodiment shown in both FIGS. 5 and 6 and the embodiment in FIGS. 1-4 includes a magnetic resistant ring 7 may lie at the position where the bass sound unit 100 and the treble sound unit 2 are adjoined. The magnetic resistant ring 7 may be implemented in terms of a column structure and may be penetrated by the treble sound unit 2 while the magnetic-conductive base 3 of the bass sound unit 100 may surround the magnetic resistant ring 7. Consequently, the magnetic resistant ring 7 may isolate the magnetic fields of the treble sound unit 2 from the magnetic fields of the bass sound unit 100.

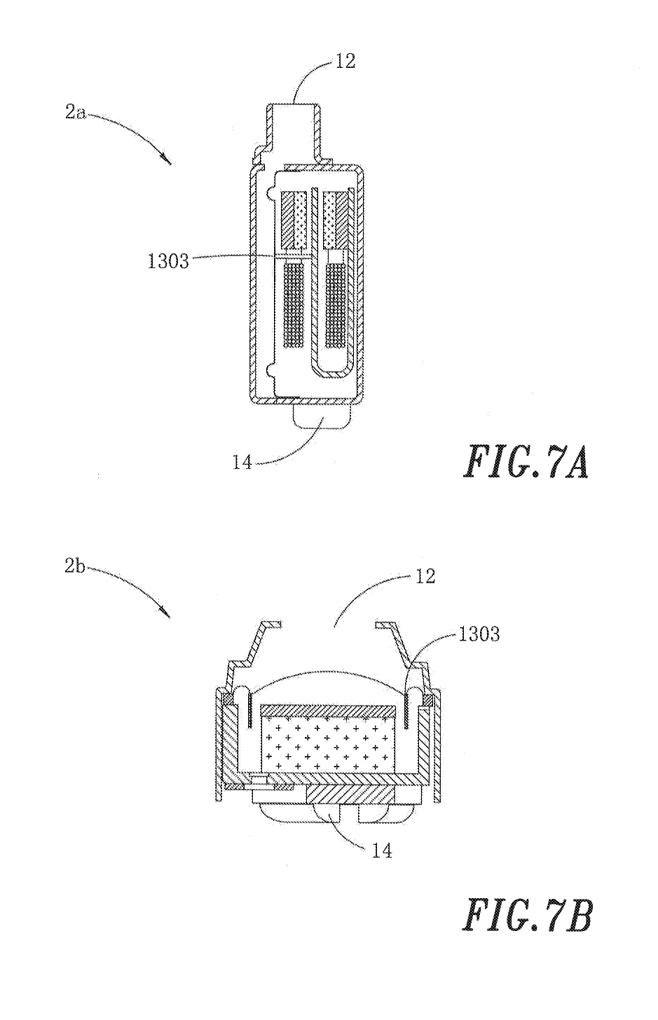

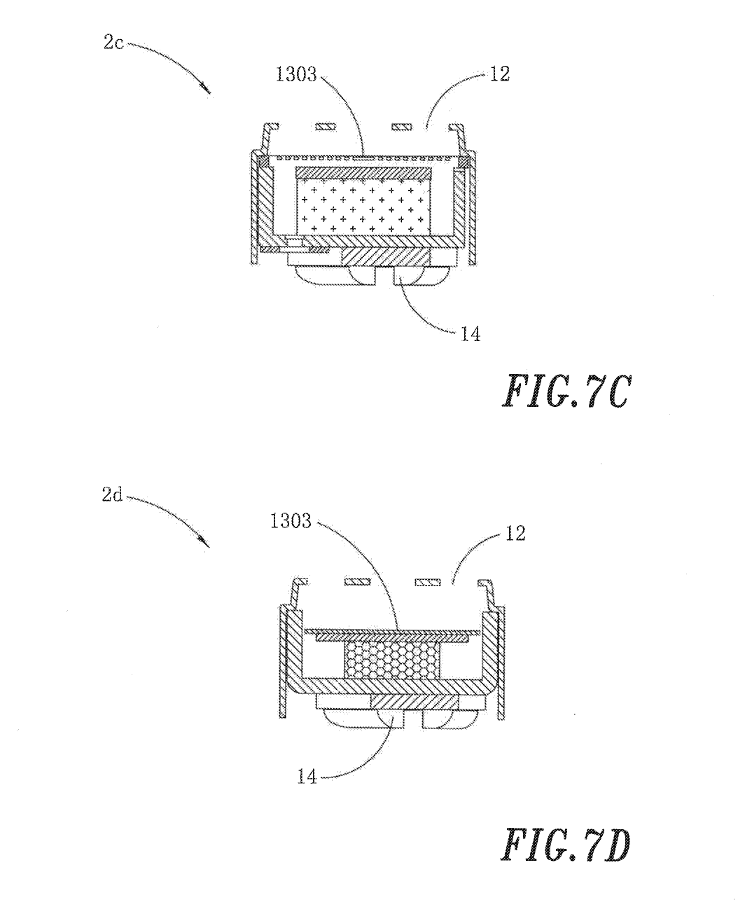

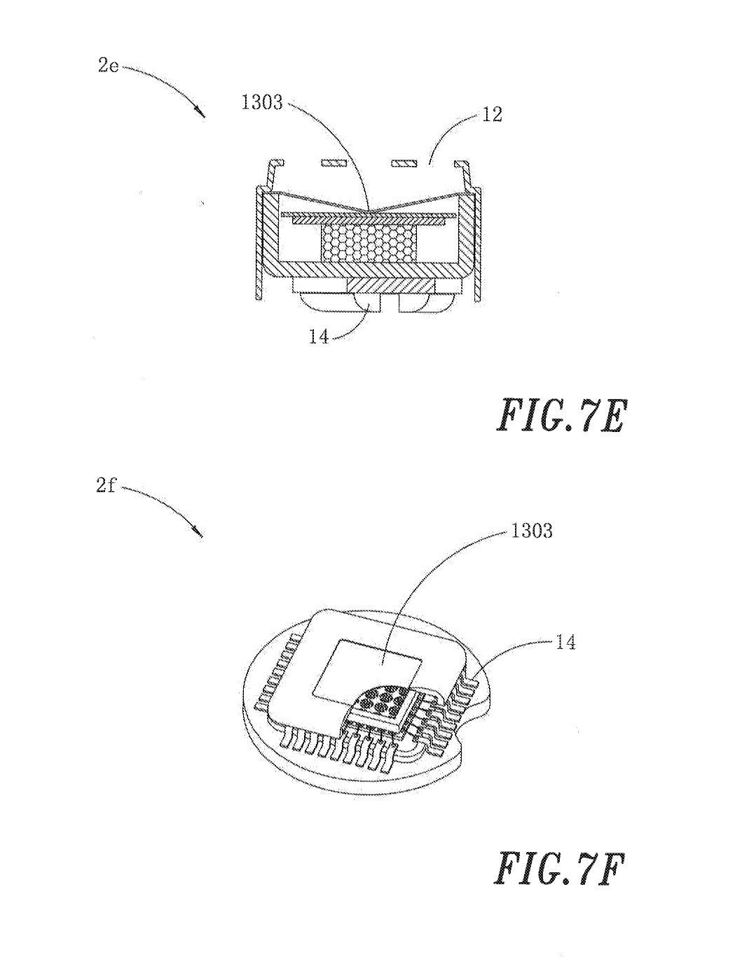

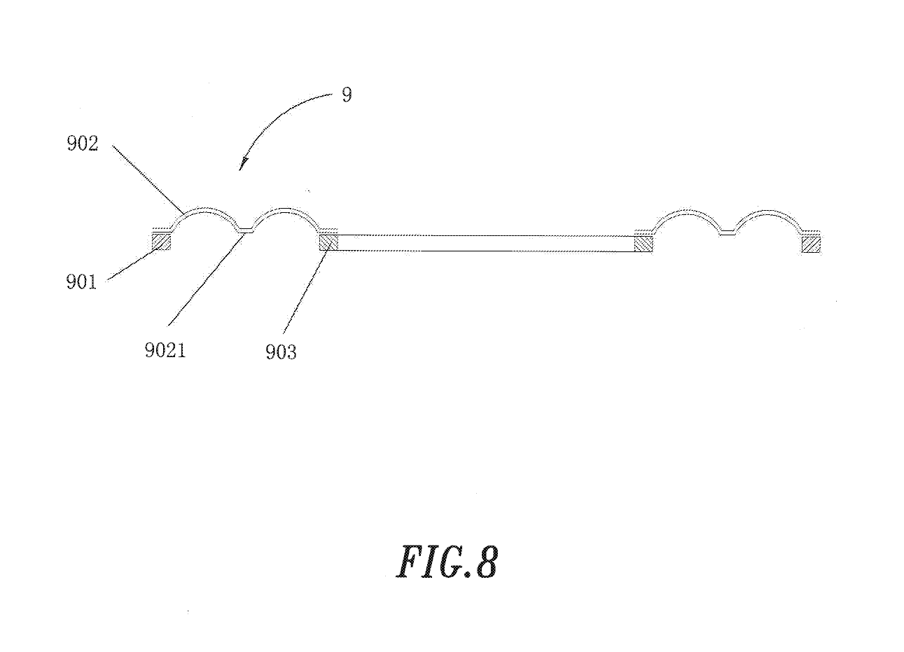

As shown in FIG. 7A to FIG. 7F, the treble sound unit 2 may be a rectangular electromagnetic moving iron sound unit 2a (FIG. 7A), a moving-coil sound unit 2b (FIG. 7B), a ribbon-type sound unit 2c (FIG. 7C), piezo-ceramic sound piece components 2d (FIG. 7D), a piezo-ceramic sound piece adjoining another vibrating vocal tone diaphragm 2e (FIG. 7E), or a semiconductor chip sound unit 2f (FIG. 7F). All of the foregoing embodiments may be used to replace the moving iron treble sound unit 2. All of the embodiments (2a-2f) in FIGS. 7A-7F may include the wiring board 14 for the treble sound unit and the vibration audio source point 1302. The semiconductor chip sound unit 2f may not be equipped with the sound hole. On the other hand, the treble sound hole 12 may be present in other embodiments 2a-2f.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

1. A coaxial audio speaker comprising:
a treble sound unit with a vibration audio source point and a wiring board; and
a bass sound unit in form of a single magnetic gap mechanism, the bass sound unit having a vibrating vocal tone diaphragm with a single vocal coil, and a wiring board;
wherein the bass sound unit and the treble sound unit are coaxially disposed and the treble sound unit is adapted to be surrounded by the bass sound unit;
wherein the vibration audio source point of the treble sound unit horizontally aligns with a vibration audio source point of the bass sound unit.

2. The audio speaker according to claim 1, wherein the treble sound unit is an electromagnetic moving iron sound unit, a circular electromagnetic sound unit, a rectangular electromagnetic sound unit, a moving-coil sound unit, piezo-ceramic sound piece components, a piezo-ceramic sound piece adjoining another vibrating vocal tone diaphragm or a semiconductor chip sound unit.

3. The audio speaker according to claim 1, further comprising a magnetic resistant ring disposed at the position where the co-axially disposed bass sound unit and treble sound unit adjoin, for separating a magnetic field of the bass sound unit and a magnetic field of the treble sound unit.

4. The audio speaker according to claim 3, wherein the magnetic resistant ring is a column structure allowing for the treble sound unit to punch through and position therein with a magnetic-conductive base of the bass sound unit surrounding the magnetic resistance ring.

5. The speaker according to claim 1, wherein the bass sound unit further comprises:
a ring-shaped magnetic-conductive base, the ring-shaped magnetic conductive base defines a hollow positioning space at its center within which the treble sound unit is positioned, a main body of the ring-shaped magnetic-conductive base has a ring-shaped accommodating space having a top opening, and the main body of the ring-shaped magnetic-conductive base forms an inner wall and an outer wall of the top opening;
a ring-shaped first magnet disposed in an inner ring and attached to the inner wall and a ring-shaped second magnet disposed in an outer ring and attached to the outer wall, and the ring-shaped first magnet and the ring-shaped second magnet collectively defines a magnetic gap;
a first magnetic-conductive ring stationed on a top surface of the ring-shaped first magnet and a second magnetic-conductive ring stationed on a top surface of the ring-shaped second magnet;
the vibrating vocal tone diaphragm having a ring-shaped diaphragm membrane stationed on ends of the inner wall and the outer wall of the main body of the ring-shaped magnetic-conductive base, a vocal coil disposed on a bottom of the ring-shaped diaphragm membrane and forms the vibration audio source point at its connection with the ring-shaped diaphragm membrane, and the single vocal coil extends into the magnetic gap between the ring-shaped first magnet and the ring-shaped second magnet; and
the wiring board disposed on an external bottom surface of the ring-shaped magnetic-conductive base providing connection wires for positioning the vocal coil.

6. The audio speaker according to claim 5, wherein the vibrating vocal tone diaphragm further comprises an external pressurized frame positioned at an outer ring edge of the ring-shaped diaphragm membrane and an inner pressurized frame positioned at an inner ring edge of the ring-shaped diaphragm membrane, the inner pressurized frame connects to the end of the inner wall of the ring-shaped magnetic-conductive base, and the outer pressurized frame connects to the end of the outer wall and encloses the top opening of the ring-shaped magnetic-conductive base.

7. The audio speaker according to claim 5, wherein a vent hole is disposed on the external bottom surface of the ring-shaped magnetic-conductive base allowing for an air associated with the vibration of the vibrating vocal tone diaphragm to be channeled out of the ring-shaped accommodating space.

8. The audio speaker according to claim 7, further comprising a flow damping gauze adhesively attached on the external bottom surface of the ring-shaped magnetic-conductive base for adjusting an air flow within the accommodating space

9. The audio speaker according to claim 5, wherein the ring-shaped diaphragm membrane is in form of composite diaphragm material.

10. The audio speaker according to claim 5, further comprising a first dust cover disposed over the bass sound unit and the treble sound unit, with the first dust cover having a first sound hole as a bass sound hole allowing for the sound from the bass sound unit to be transmitted out of the first dust cover, and a second dust cover having a second sound hole as a treble sound hole allowing for the sound from the treble sound unit to be transmitted out of the second dust cover.
